(19) United States
(12) Patent Application Publication
(10) Pub. No.: US 2008/0301176 A1
(43) Pub. Date: Dec. 4, 2008

(54) ELECTRONIC VOICE-ENABLED LABORATORY NOTEBOOK

(76) Inventors: Joseph Fanelli, Escondido, CA (US); Samuel Beckey, Rancho Santa Fe, CA (US); Lane Watson, Burlington, NC (US)

Correspondence Address: CATALYST LAW GROUP, APC, 9710 SCRANTON ROAD, SUITE S-170, SAN DIEGO, CA, 92121, US

(21) Appl. No.: 12/131,787

(22) Filed: Jun. 2, 2008

Related U.S. Application Data
(60) Provisional application No. 60/941,568, filed on Jun. 1, 2007.
(60) Provisional application No. 60/954,221, filed on Aug. 6, 2007.

(51) Int. Cl. G06F 17/00

(52) U.S. Cl. 707/102; 707/E17.001

(57) ABSTRACT

A system for record keeping in scientific, industrial, and commercial applications where records are used to document inventions and discoveries, such as in a research laboratory is disclosed and described herein. Such systems are referred to in the applicable field as Electronic Laboratory Notebooks (ELNs). Also disclosed is an improvement to ELNs such that a facilitated data integration step is performed in order to create connections and relationships between objects of information. The data integration step allows the researcher to bring together information from various record keeping systems, to include ambient, real-time data provided by voice. The integration is further facilitated by one of more of the following: graphical display, smart pen, data object manipulation; images from lab notebook pages, and a voice recognition capability.

### PRIORITY CLAIM

This patent application contains subject matter claiming benefit of the priority date of U.S. Provisional Patent Applications Ser. No. 60/941,568 filed on Jun. 1, 2007, and entitled METHOD AND PROCESS FOR ANALYSIS OF THE CAPTURING OF TEXTUAL DATA AND CONVERSON OF SAME TO ELECTRONICALLY ACCESSIBLE TEXT; also Ser. No. 60/954,221 filed on Aug. 6, 2007, entitled MODULE FOR CAPTURING INSTRUMENTATION DATA AND METHOD OF PROCESSING SAME, accordingly, the entire contents of these provisional patent applications are hereby expressly incorporated by reference.

### BACKGROUND OF THE INVENTION

1. Field of the Invention

The present invention pertains generally to data integration, unification and record creation in support of intellectual property. More specifically, the present invention relates to systems and methods for capturing and compiling various forms of research data and converting same to an electronically accessible and searchable database. The present invention, in a preferred embodiment, is particularly but not exclusively, useful as an Electronic Laboratory Notebook (ELN) that employs various forms of voice recognition techniques that can additionally process multiple forms of raw data and relate such data to a unified system searchable and shareable among a wide distribution of scientists and researchers while satisfying legal, regulatory and scientific requirements.

2. Description of the Prior Art

Laboratory notebooks are used daily by scientists and technicians to record hypothesis, experiments, results, information, and interpretations generated by their research. This information or knowledge is traditionally handwritten, and contains experiments and observations as well as the researchers' progress in proposing and testing scientific hypothesis and novel inventions. The intellectual property contained therein is highly valuable and is the eventual result of all research.

There are advantages of maintaining the information from laboratory notebooks in electronic form. These include: efficient integration of data from various sources in the lab, better sharing of information among researchers in a team environment, protection of the resulting intellectual property, and other improvements.

While Electronic Lab Notebooks (ELNs) have been heretofore proposed, scientists and their organizations however have been reluctant to change traditional methods and the paper lab notebooks remain the standard. Even when ELNs are in use, typically in addition to maintaining paper or electronic lab notebook pages, a laboratory will be served with some or all of a range of cumbersome data handling capabilities. These include data stores on computers, databases, images, tabular test results, serial data streams, paper receipts and printouts, inventory transactions, and output from robotics processes. Even spoken comments of the scientist and researchers in the laboratory create a source of data. Each of these sources is potentially of tremendous value to the sponsoring organization.

The desire to convert speech to text has long existed. The first speech to text (STT) or voice recognition (VR) systems were manual systems in which while one person spoke, a second person keyed the spoken words into a typewriter in real time. The advent of magnetic storage media for voice recording enabled the first person to dictate words onto a media, such as a tape, that could be replayed at a later and more convenient time for the second person who performed the transcription.

The subsequent widespread use of the personal computer later gave rise to renewed interest in STT systems. Using known STT systems, a computer user could speak into a microphone and have his/her voice converted into words that appeared on a display screen.

In general, STT systems may be generally classified as speaker independent or speaker dependent. Speaker independent systems are not conditioned to a particular speaker's voice and, thus, are geared to recognize words spoken by a number of different speakers. Speaker dependent voice recognition systems are user-specific systems that must be “trained” by a speaker reading proscribed words into the systems to enable the system to recognize the manner in which such words sound when uttered by the speaker. In general, speaker dependent systems have high recognition accuracy and better performance in noisy environments than their speaker independent counterparts. Additionally, speaker dependent systems generally operate using less processing memory and can perform STT conversion at a higher rate than speaker independent systems. However, as noted above, speaker dependent systems must be voice trained by each speaker to be recognized.

Currently, STT systems focus on converting speech to text for users that are executing computing applications on a particular computing system. That is, modern STT systems are trained by a particular speaker whose speech will be converted to text and that speaker dependent training data (SDTD) remains on that trained system. Presently, SDTD systems are inaccurate and inefficient, resulting in a need in the art to achieve a higher accuracy rate when converting from speech to text.

Another problem associated with the prior art is that heretofore many of the various data sources implemented in scientific research remain on islands. Additionally, certain raw data with temporal elements can be lost or not easily discoverable, searchable or shareable at a later time.

In light of the above, it is an object of the present invention to provide an Electronic Voice-Enabled Laboratory Notebook “Evelyn” system and-method that integrates and interfaces various forms of raw data and compiles to another form that is retrievable and searchable by subject, methodology or protocol, for example. It is further an object of the present invention to provide a system and method of laboratory data integration that can be shared by scientists world-wide, in many languages, and sharable, for example in multicenter trials for clinical research centers. It is still another object of the present invention to provide a system and method that achieves the advantages of an integrated electronic lab notebook while retaining and enhancing a range of existing laboratory centric information systems. Yet another invention objective is to provide a system that maintains an adequate record of intellectual property conception and reduction to practice meeting a legal standard of proof, as well as meeting regulatory requirements such as those set forth in the United States, Title 21 Code of Federal Regulations, Sect. 11, electronic signatures for food and drug industries, laws primarily executed by the FDA, the U.S. Food & Drug Administration. Still another invention objective is to provide a system and method of recording data with one-way hashing, so that ambient, real-time data cannot be subsequently manipulated; however further providing capability to rank and score data, so that certain undesirable data could be discarded. It is another objective to provide knowledge management, and in work for hire situations, the present invention provides a more definitive record of work that was completed in a work for hire arrangement so that ownership of intellectual property is more definitive.

### BRIEF SUMMARY OF THE INVENTION

The present invention specifically addresses and alleviates the above mentioned deficiencies, more specifically, the present invention in a first aspect is a system of recordkeeping in research and commercial applications comprising: a collection of data objects from a plurality of data sources using a plurality of data interfaces; a graphical user interface, wherein the data objects representing laboratory are organized and approved by researchers; and a voice annotation instrument for providing data collection annotation, notes, and comments wherein such voice data collection may or may not be transcribed, and wherein the system facilitates creation and management of intellectual property.

The system of recordkeeping is further characterized wherein data objects are authenticated and secured from subsequent modification using one-way hashing. Additionally, the system of recordkeeping is characterized wherein the plurality of data objects are indexed and represent a logical grouping of research activity, and further allow for paging such as provided in a traditional lab notebook.

Still further, the system of record keeping is characterized wherein the graphical user interface is controlled partially or completely by voice commands, and wherein the collection of data objects further comprises instrumentation data, and wherein the instrumentation data is selected from a group consisting essentially of mass spectrometers, camera images, microscope images, video, and chromatographs.

Yet still further, the system of recordkeeping is characterized wherein the researchers organize data objects according to organizational criteria, time, protocol, personnel, consumables, or sample identification, as applicable; and wherein the graphical user interface is controlled partially or completely by a smart pen.

Moreover, recordkeeping system is further characterized wherein a system user is guided through the creation of an integrated data record by transcribing a scanned lab notebook page or wherein the user is guided through the creation of an integrated data record by following an electronic lab notebook entry, and wherein, the integrated data record is distributed to a relational database management system (RDMS), with a generation of indexes comprised of metadata in the data record wherein the metadata further describes the data objects.

In a second aspect, the invention is a method of voice data collection in a recordkeeping application as a way of converting data into electronically accessible text, the method comprising: training a software program to recognize a user voice having a substantially high accuracy; providing a technical database of scientific terms to enhance the software program to accurately recognize technical terms; providing a database of scientific symbols to enhance the software program to accurately recognize and convert technical characters to text; reading the data to be converted to text to the software program; converting the data to text using the software program; and supplementing the data with applicable analytical or empirical data directly from scientific instrumentation wherein the resulting text is electronically accessible.

Additionally, the method of processing data of the present invention further comprises recording data to a lab notebook, preceding the step of reading the data to be converted to text to the software program, wherein the data further includes date and time information.

Still further, the method of processing data also comprises: providing to the software program a rules engine for quality assurance; and validating results to further increase accuracy of the method. Also it comprises indexing the electronically accessible text selectively as desired by the user; and interrupting the electronically accessible text to enhance the usefulness thereof. This method is further characterized wherein the data is laboratory data. Also, the method further comprises supplementing the data with internet sources of research, the sources of research chosen from a group consisting essentially of a protein databank, a chemical structure libraries, and a genomic database.

In still a third aspect, the invention is a method of recordkeeping comprising: collecting a plurality of data objects from data sources; assembling the data objects to an integrated electronic notebook record; assisting the assembly of data objects with computer assisted voice interaction; securing the assembly of data objects so that said data remains uncorrupted; storing the assembly of data objects; and translating (142) the assembly of data objects to Extensible Markup Language (XML) to facilitate the sharing of structured data across an information system, for example the Internet.

Further, the method also comprises distributing the assembly of data objects to a relational database management system (RDMS); and generating indices comprised of metadata in the data record. Furthermore, the method comprises providing a statistical analysis package with the assembly of data objects; providing pattern and clustering algorithms related to the assembly of data objects; providing data mining tools related to the assembly of data objects, for example searching within the assembly of data objects by a protocol; maintaining a modular software and hardware design so that existing labs can implement said method of recordkeeping relatively easily. Additionally, the method includes presenting the assembly of data objects using graphical data visualization tools; and recording a status, the status chosen from a group consisting of DRAFT, COMPLETE, APPROVED, RELEASED, or CANCELLED.

Yet still further, the method of recordkeeping is characterized wherein the collecting a plurality of data objects from data sources comprises ambient data from real-time voice annotation, and wherein the assisting the assembly of data objects with computer assisted voice interaction comprises a speaker independent voice dictionary, a special domain specific scientific vocabulary, and a voice trained individual vocabulary, the method further comprising ranking and scoring the data objects for subsequent decision makings regarding the accuracy and usefulness of the data objects.

While the apparatus and method has or will be described for the sake of grammatical fluidity with functional explanations, it is to be expressly understood that the claims, unless expressly formulated under 35 USC 112, or similar applicable law, are not to be construed as necessarily limited in any way by the construction of “means” or “steps” limitations, but are to be accorded the fall scope of the meaning and equivalents of the definition provided by the claims under the judicial doctrine of equivalents, and in the case where the claims are expressly formulated under 35 USC 112 are to be accorded full statutory equivalents under 35 USC 112, or similar applicable law. The invention can be better visualized by turning now to the following drawings wherein like elements are referenced by like numerals.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a flow chart depicting an Evelyn (Electronic Voice-Enabled Laboratory Notebook) session with raw data input to the left thereof and indexable and searchable information resulting from the raw data;

FIG. 2 depicts an internal software implementation of one embodiment of the Evelyn technology;

FIG. 3 is a flow chart showing a voice recognition interface embodiment of the present invention; and

FIG. 4 is a flow chart further illustrating output of unified and integrated data.

### DETAILED DESCRIPTION OF THE PREFERRED EMBODIMENTS

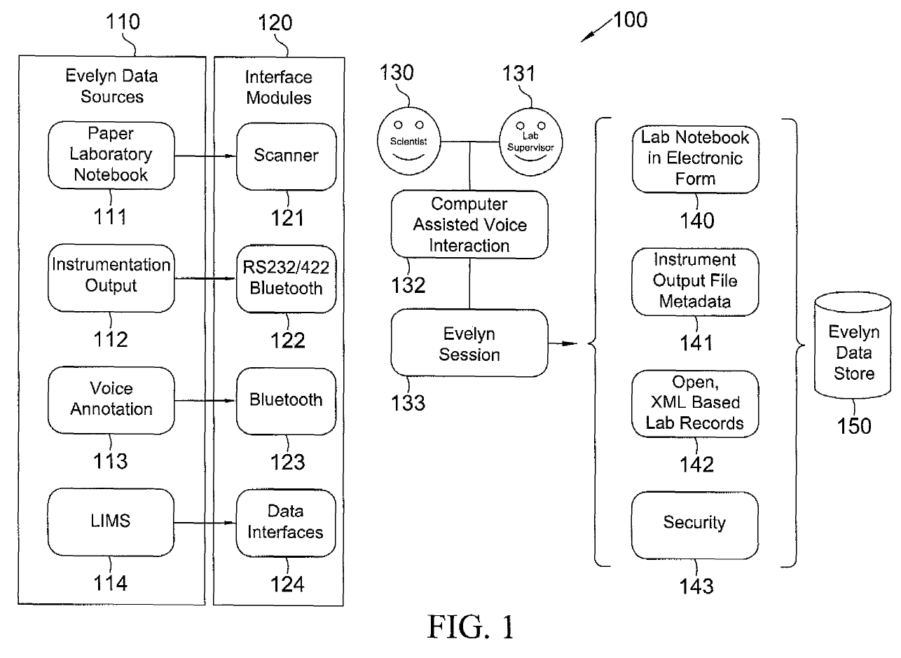

Referring initially to FIG. 1, a functional overview of a dataflow of an invention embodiment 100 is illustrated. More specifically depicted is an Evelyn Session 133 that is an acronym for the title of the present invention, Electronic Voice-Enabled Laboratory Notebook. On a left side, various data sources 110 and four specific examples 111, 112, 113, 114, are given. Other raw data sources 202, 203, 204 311, 312, 313, 314, will be additionally described herein. Information is collected from the data sources 111, 112, 113, 114, in a series of interface modules 120, specifically scanner 121, wireless modules, for example Bluetooth, 122, 123, and LIMS (Laboratory Information Management System) interface. In the prior art, LIMS has been mostly limited to restricted sample monitoring or basic results entry for drug, protein, gene screening, or DNA handling. The present invention 100, 200, 300, 400 may be viewed as advanced LIMS with specific input and output modules for uses and solutions specifically in data integration and unification.

Interface modules 120 of the present invention may be realized as readily available commercial software; and in other cases a special interface module is specifically developed for the purposes of the invention. Where possible, initial data validation, timestamp 216, and data security described later via one-way hashing is performed by the data interface module 120; or alternatively this is accomplished by a security function 143 to maintain integrity of the raw data.

According to an Evelyn Session 133 of the present invention, on a periodic basis, for example at least by the end of a work day, a new process is performed by a principal scientist 130 and a lab supervisor 131. Thus, a plurality of research personnel 130, 131 work with software to bring together the various data sources 110, and convert the data into an optimal index and contextually related form 140, 141, 142, 220. Voice interaction 132 is provided to facilitate data processing include commands notes, and transcriptions. Moreover, voice annotation 113 is also provided to include contemporaneous notes, not entered by paper or a separate ELN. For example, if a laboratory sample is possibly contaminated it could be made record by voice. Or theoretically, if only 10 cc of a reactant is desired, instead of a standardized 50 cc amount, then this could be annotated 113 by voice. The session, 133 combines related data objects created through the data interfaces into results 150.

In a preferred embodiment, a session 133 may be performed as logically dictated by the flow of work in a laboratory, such as when an experiment is completed, or it 133 may be performed later, but still in a timely manner so that the researchers are maximally familiar with the data objects 111, 112, 113, 114, 202, 203, 204 311, 312, 313, 314 generated.

Scanned handwritten notebook pages 111, written notes, and drawings are additionally easily incorporated via a scanner 121 that converts pages 111 at a high resolution to digital images. Where narrative text is contained on the scanned page, the researcher 130 can use voice recognition capabilities 132 to dictate and approve a transcription. Where it is suitable, handwriting recognition software can also aid in transcription as yet another input to the Evelyn session 133. It will be the decision of the laboratory managers 131 as to how much transcription is required. Indexed and searchable text will aid in the maximum utilization of the laboratory data 110.

In another embodiment, existing or future Electronic Lab Notebook (ELN) software itself will be an input to the system, and will be integrated as with any other data source. Additionally as another example, most LIMS 114 inputs will contain data originally from various ELNs from a variety of other researchers. An advantage of the invention 100, 200 is the ability to include any source of information in the laboratory into the resulting record keeping system, using the appropriate data sources and interface modules, to create data objects.

Laboratory data sources 111, 112, 113, 114, 202, 203, 204 already in common use include various kinds of instrumentation 112. These can range from chromatographs (devices that measure and quantify a color), simple lab meters (pH, balances, etc.) to elaborate instruments that create images (microscopes, plate readers) and even devices that read or generate genomic sequences. Many of these instruments 112 already have various capabilities to create digital records and interface in a variety of ways 122, such as RS-232, RS-422, Bluetooth, WIFI, and TCP/IP via Ethernet.

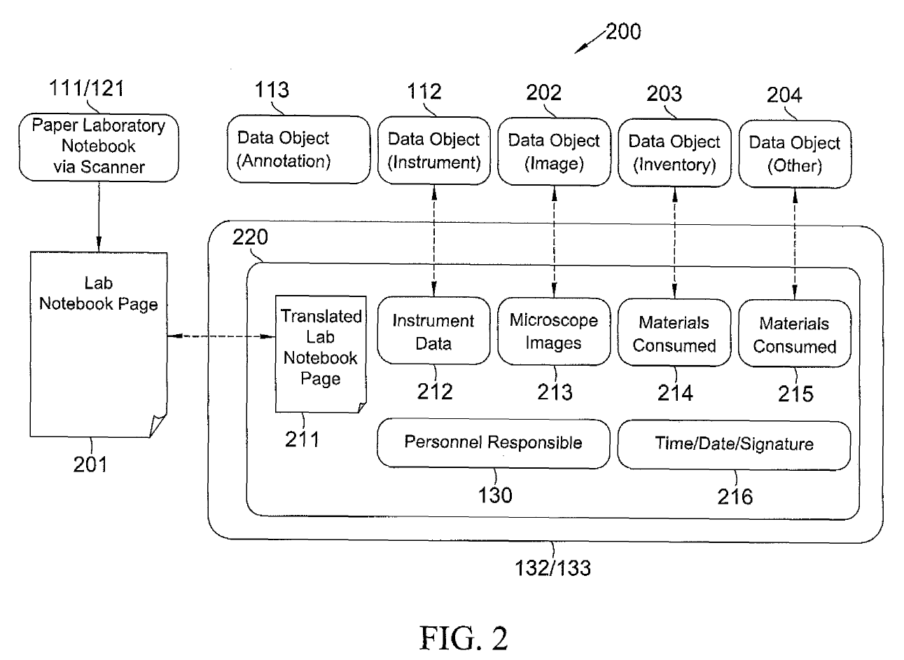

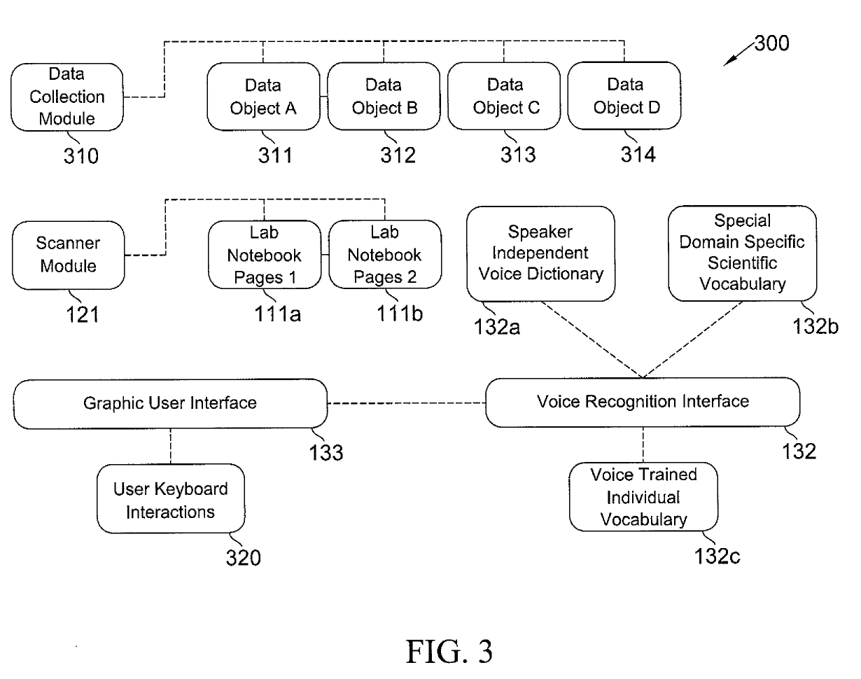

In addition to instrumentation 112, the subject invention provides for collection of all relevant information in the laboratory environment. This is referred to as ambient data collection. As stated, one specialized source of ambient data collection is voice annotation 113. Using a microphone, or a wearable Bluetooth headset, the researcher can easily make contemporaneous comments, instructions, or provide supplemental data to a process in the laboratory. This information passes through a data interface which authenticates the sender, timestamps the data, secures the information and creates a data object (FIG. 2 and FIG. 3) for use in a later session 133.

Another example of raw data 110 input is laboratory inventory management applications 202, where tracking and resupply of consumables such as reagents, oligos, chemicals, buffers, media, and labware are provided. These systems maintain inventory of storage locations including warehouses, closets, freezers, and bench contents.

Further to sources of raw data, it can be seen that there are a variety of systems in nearly every laboratory, but that there has been no heretofore comprehensive record keeping system integrated with all potentially useful sources of documentation. The present invention addresses this problem from a design standpoint, and as a practical matter is capable of integrating information from all known data sources in research.

It should be noted that some of the data objects 111, 112, 113, 114, 202, 203, 204 created can be very large in size, and that this is not a practical limitation of the invention. Information storage capability has greatly increased; and the cost of storage is such that it is desirable to keep the most detailed information in the system, as long as it is properly organized. In this system, all data is retained in its original form, and then supplemented with metadata (data describing the original data), all of which is secured indexed, and managed.

The present invention still further anticipates the future development of ambient data collection systems. In the future, all sources of relevant information will be available for incorporation into a record keeping system. The invention allows this to happen by providing a method of organizing such data into meaningful records, and incorporating novel data sources such as voice recognition 132 into the record keeping process.

In laboratories today, the present invention can easily be configured to accept input data from a variety of data sources 110 or data collection modules 310 (FIG. 3). Instrumentation can include specific data sources for particular scientific domains. Yet still further, these would include sources such as mass spectrometers, molecular structure drawings, images from cameras and microscopes, sound and video clips, automation sequencing and programming files, various slide readers, chromatographs, and various instrument and system reports.

Computers in use in laboratories produce files which are another source of data objects for input into the system 100, 300. Any software application, or specific scientific application with its own file format can be captured and encapsulated by the record keeping system 100, 200, 300, 400. Internet sources of research, such as the protein databank, chemical structure libraries, and genomics databases can be referenced, or their relevant contents can be incorporated.

An Evelyn session 133 most likely begins with the imported data objects 110 representing the scanned and processed laboratory notebook page 111. This accommodates current methods familiar to all trained scientists in addition to providing a logical method of documenting lab activities. Lab notebooks 111 are not required for the present invention however, and may be avoided if the organization feels other data objects are available which adequately described the lab activities. These could include voice annotations 132, for instance. Additionally, the present invention maintains a modular software and hardware design to a maximum extent possible so that existing labs can implement the present invention to their existing equipment and software, or mix and match according to preferences in equipment or vendors provided by said modularity.

Using a guided process, a researcher selects and organizes data objects using a graphical user interface 133 (FIG. 3). Data objects 111, 112, 113, 114, 202, 203, 204, 311, 312, 313, 314 can be sequenced, nested, grouped, and linked to accurately represent the sequence of laboratory activities. Tools to aid organization of data objects are additionally provided by the present invention, including organization by hierarchical protocol, physical location, sequence number (as in a barcoded media application), consumable identification, and by personnel. Therefore, the Evelyn data store 150 is searchable by all of the above as well as key word and temporal identifiers.

Referring to FIG. 2, at the conclusion of each lab notebook page (or any other functional grouping of work if the lab notebook is not used) the researchers 130, 131 sign-off by attaching electronic signatures 216. Multiple signatures 216 are required where there is a legal requirement for a witness. And importantly, the invention provides an excellent way for Intellectual Property (IP) Departments to keep track of records evidencing conception and reduction to practice of novel discoveries. With each signature 216, as with the individual data objects 110, 202, 203, 204, 311, 312, 313, 314 there is a one-way hash function performed which locks the object or the page from further manipulation. The current state of the art in encryption technology allows this to be accomplished in a manner consistent with United States law promulgated in Title 21 of the Federal Code of Regulations (21 C.F.R.) Sect. 11, electronic signatures required in food and drug industries. Electronic signature 216 techniques should be familiar to those skilled in the art. Further, individual identification of the researchers 130, 131 can be accomplished with properly managed passwords, token based systems (dongles, keys, USB sticks), or even biometric authentication according to the needs of a particular institution.

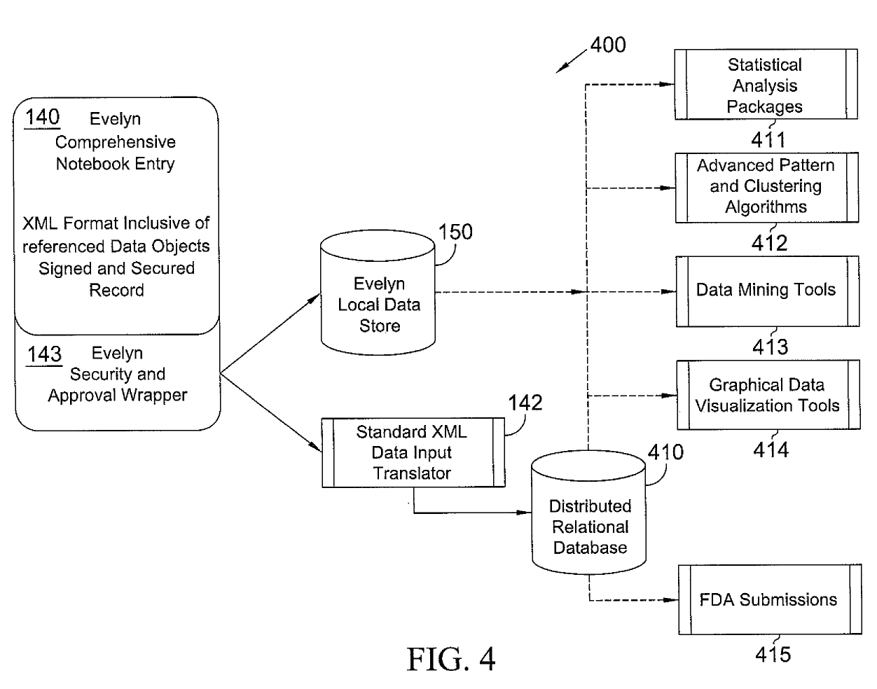

At an output of the Evelyn Session 133, the eventual data is stored 150 as shown in FIG. 1 and in FIG. 4. This record contains all the data objects, organized, indexed, and linked, along with protocols, activities, inventories, personnel, and the associated security information. The collection of results records is designed to be an acceptable lab notebook in electronic form and exceeds the requirements of information security of intellectual property records, to include information protected as proprietary trade secret, by using the same techniques used in modern secure and encrypted systems 143. The resulting record also includes all the original imported data from data sources and is formatted in an open and extensible manner 142 such as XML (eXtensible Markup Language) for easy manipulation in a variety of data storage, warehouse, and analysis tools.

Referring more specifically to FIG. 2, an example information flow within the session is shown; and using as an example, data organized in the traditional lab notebook manner. Other organization principles are possible, including by protocol step, according to a work instruction, in a tabular format, by inventory identifier, or strictly chronologically. During the normal operation of a research organization, under current best practices, a researcher will maintain a paper or bound book form laboratory notebook 121. In it 121, the researcher will record their observations, procedures, hypothesis, and results, as well as ancillary narratives and comments.

Furthermore, the present invention provides a way for traditionally conducting research to continue and complements it with more detailed information directly from other laboratory sources. As discussed in FIG. 1, information is prepared as data objects 111, 112, 113, 114, 202, 203, 204, 311, 312, 313, 314 by the data interface programs 120. These data objects are held in a database; and until they are used or consumed they are shown on a graphical user interface display 133 (FIG. 3), in a manner similar to files on a computer desktop.

The graphical user interface 133 can be thought of as an integration station for data of various types acquired by data interface programs 120, and represented as data objects. Using the scanned image of the lab notebook pages 111a, 111b as a guide, the researcher can perform a variety of functions, as follows.

Transcription Function 211: allows the researcher to read the handwritten notes directly from a notebook image and create a computerized record of the notation. Because researchers will most likely be reading their own or a team members handwriting, the person most qualified to interpret the data correctly is called upon to complete this function 211. In modern labs, multiple languages of the staff are common, so these notations and transcriptions will not always be in the native language of the laboratory management or the organization.

Metadata Function: allows a researcher to associate any data object 111, 112, 113, 114, 202, 203, 204, 311, 312, 313, 314 with metadata elements. The metadata elements include, but are not limited to: personnel (researcher or team member responsible for the data in a hierarchical form), protocol (the formal or informal work instruction step being performed, also in a hierarchical form), inventory item (identification of the media, slide, plate, or container used, probably by barcode identification). Stated differently, metadata is a source of context for data objects. By enhancing the data objects with metadata, we make the data reusable, and searchable. The graphical user interface 133 allows the metadata to be specified by the researcher 130, and maintains the organization of metadata objects. For instance, in an example application, an experiment and its work instruction steps might be a form of metadata. The lab organization structure is another form of metadata, and might be organized in an organizational chart type of structure. Protocols have hierarchical structure and can be maintained by the system. The physical layout of the facility into buildings, labs, benches, and workstations can also be represented.

Annotation Function 113: allows the researcher to directly enter new information as a new data object.

Inclusion Function: allows the researcher to attach computer files or Internet (http://) references as data objects.

Data Object Function: allows the researcher to include a data object at a given point in the resulting Evelyn record 220.

Edit Function: allows the user to modify the contents of certain data objects by recording the changes applied to a copy of the original and still secured data object. This maintains a complete audit trail of any modifications to data in the system 200.

The graphical user interface 133 creates a Secure Assembled Electronic Lab Notebook Record 220 from the users 130 operations, each record corresponding in this example to a page from a paper laboratory notebook 111. Of course the limitation of physical page size no longer applies and pages 220 can be grouped into longer objects called chapters if necessary.

As stated, each data object 111, 112, 113, 114, 202, 203, 204, 311, 312, 313, 314 is maintained in its original form, with a one-way hash function to assure its integrity. Once Assembled Secure Electronic Lab Notebook Records 220 are created by a user, they are marked with the personnel responsible (a metadata function) 130, date and time based on a secure time server connection 216, and electronic signature information of a person creating the record.

A status is recorded for the record, for example assigning it to DRAFT, COMPLETE, APPROVED, RELEASED, or CANCELLED status and another one-way hash is performed after each status change. The status choices can be assigned by the organization for most efficient operation or to meet regulatory requirements.

It should be further emphasized that the Assembled Secure Electronic Lab Notebook Record 220 contains a logical union of all its component data objects, along with metadata and linkages created by the researcher between those objects. Hence, no data is lost in the conversion process.

Referring to FIG. 3, further details of an internal logical construction of an integration station 300 are illustrated. A graphical user interface 133 can optionally include functionality of a voice recognition interface 132. An objective of the voice recognition interface 132 is to increase performance and speed in which the researcher can assemble data records. An analogy can be made to radiology workstations in medicine, which are currently a state of the art example of the possibilities and efficiencies offered by voice based interfaces, complemented with high resolution graphics in a graphical user interface 133.

The voice recognition system 132 has a responsibility of not only applying commands to the graphical user interface 133, but also transcribing freely spoken text. The problem is further complicated by the variations in different speakers in the lab, and the highly specialized different vocabularies found in differing scientific disciplines.

Therefore, the voice recognition system 132 is enhanced by commercially available, speaker independent voice dictionaries 132a. These recognition systems are well described in their respective literature (e.g. IBM Dragon Naturally Speaking or equivalent). In the present invention, the speaker independent dictionary is supplemented with a Special Domain Specific Scientific Vocabulary 132b that is a user modifiable trained dictionary of scientific terms. The user may be identified by personnel information and his or her account preferences to use a specific discipline vocabulary.

Yet still, because individual researcher 130 success may be inadequate with the speaker independent dictionaries, the system also provides the option of individually voice trained vocabulary dictionaries 132c that are specific to each user. This allows the system 300 to accommodate virtually any user and speaking style. The three vocabularies 132a, 132b, 132c, are used simultaneously so that both commands and transcription are possible by voice interface 132. This interface could be implemented in a plurality of methods, using hardware and software from the marketplace. As an example, a Bluetooth headset maybe an interface for a scientist 130 or technician to communicate with Evelyn 133.

In yet another preferred embodiment, Graphical User Interface 133 is supplemented or realized with a smart pen. Accordingly, the smart pen remembers what it writes and coverts to electronic text; and the smart pen could include the voice recognition interface 132; and still further the smart pen could be used to drag, drop and manipulate objects to the electronic notebook record 140, 220.

According to FIG. 4, a session 133 output 400 and a disposition of data from the system 100, 200, 300 are further described. A Comprehensive Notebook Entry 140 is equivalent to the Secure Assembled Lab Notebook Record 140 (FIG. 1 and FIG. 2). The entry can be made available in XML format 142 from the system, and can include nested structures representing encapsulated data objects as well as one-way hashes, electronic signatures, timestamps 216, and status. The record 140 can be viewed and managed in the application itself, printed and rendered in PDF (page description format), and exported to a relational or object oriented database 410.

The application maintains a local data store 150, which is used to allow researchers 130, 131 access to completed records. In a relatively small installation, it may be the only database available. In a larger installation, the system interfaces via XML export 142 to a relational database management system (RDMS) 410. These systems 142 are commercially available, and achieve nearly perfect data security and availability over large dispersed installation across geographical areas. In addition, there is practically no limitation to the size of the database. Load sharing can be possible, which allows maximum performance over large databases.

As stated, the program 400 maintains a local database 150 allowing users to easily page through their research records. Through standards based programs using XML 142, Evelyn 133 will export records 140, 220 as they are created to the institutional choice of relational database management systems 410. These can include Oracle, SQLserver, MySQL, INGRES or others. The RDBMS 410 can be configured to collect data from multiple instances of Evelyn 133 in different labs or geographical locations. It also can provide security by storing information redundantly and dispersed throughout the enterprise. In a small organization, Evelyn 133 can be configured to use a local database only 150, with the same potential capabilities. The relational databases 410, whether local or enterprise wide are the source of information for advanced data analysis, which can include statistics, correlations, long term data accumulation, query, and analysis.

Either or both database structures 150, 410 are the source of information for subsequent processing 411, 412, 413, 414, 415. Typical applications would include report writers, statistics packages 411, data mining 413, visualization and graphical presentation tools 414.

By providing integration of all the supported data sources 111, 112, 113, 114, 202, 203, 204, 311, 312, 313, 314 the subject invention allows management and query of the resulting data in ways not previously practical. Data collected is now contextual and the relationships between data are defined and usable. It is further contemplated that the present invention is ideal for employers' conducting exit interviews in the research area. Under the work for hire doctrine, intellectual property of employees is owned by the employer or the entity contracting for such work to be performed. In an exit interview, an employer manager can very easily present any intellectual property conceived by an employee for acknowledgement by employee to minimize the chance of a later disagreement as to the owner of such intellectual property.

Yet still further, the present invention is ideal for biotechnology CEOs in making the very difficult decision to quit on a drug development, for example, even after making substantial investments toward possible development, approval and commercialization.

### EXAMPLE

It's the end of the day in Nobel Prize-winner John Doe's Lab. His team of researchers and post-docs has been busily-performing experiments all day. Before they head out to the campus rathskeller, a short visit to Evelyn 133 is a good idea.

Bob Smith, a technician, logs in to the Evelyn 133 workstation. Using a secure password or a token ID, or both, he sits before a graphical user interface screen 133. Bob is wearing his usual Bluetooth headset 123, that he often talks into during the day. On the screen 133, Bob sees an array of graphical objects 111, 112, 113, 114, 202, 203, 204, 311, 312, 313, 314 representing the work results from the lab. When he used an instrument 112 during the day, its output probably created one of more of the objects. Each time he accessed the stockroom, or moved something to or from a freezer, more data and another object were created.

Next, Bob also is able to scan his traditional lab notebook 111. Modern scanners 112 easily process hundreds of pages per minute, but Bob's handwriting like most scientists, is barely legible. As a few pages are scanned, Bob is able to select from menus on a screen that his work was a continuation of the previous week's research. He does this by talking into his Bluetooth headset 123. Evelyn 133 now knows what research area is being addressed and the special scientific vocabulary 132b for Bob and this project.

Similar to a radiologist interpreting an X-ray, Bob sees his own lab notebook pages 111a, 111b on the display. Using his voice, he can quickly read passages and the system displays text generated to match the lab notebook 111. Where data is incorporated, he gives voice commands to include data objects from the on-screen display into the resulting composite record 220. He can zoom in on the recorded data objects 211, 212, 213, 214, 215 to see them in more detail. Sometimes the data object will be a microscope image 213, or a sequence from a DNA analyzer, for example, which he can see in detail. He can also incorporate handwritten drawings directly from the paper lab notebook 111.

When his Evelyn session 133 is completed, Bob can securely sign 216 the electronic notebook records 220. A bit later, John Doe logs in and has the same experience, eventually indicating his approval with another electronic signature 216.

It should be noted that the resulting electronic lab notebook 100, 200, 300, 400 is not a replacement for a paper system, although in time it may change requirements to maintain paper notebooks. The new information system supplants the narrative approach to documented research with a more comprehensive collection of data 110, 202, 203, 204, 311, 312, 313, 314, collected from as many lab sources as possible. Use of voice recording and recognition allows narrative notes and notebook entries to be recorded in real-time and closely associated with the operation being performed.

Many alterations and modifications may be made by those having ordinary skill in the art without departing from the spirit and scope of the invention. Therefore, it must be understood that the illustrated embodiments have been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

While the particular Electronic Voice-Enabled Laboratory Notebook as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

What is claimed is:

1. A system (100, 200, 300, 400) of recordkeeping in research and commercial applications comprising:
a collection of data objects (111, 112, 113, 114, 202, 203, 204, 311, 312, 131, 314) from a plurality of data sources (110) using a plurality of data interfaces;
a graphical user interface (133), wherein the data objects representing laboratory are organized and approved by researchers; and
a voice annotation instrument (132) for providing data collection annotation, notes, and comments wherein such voice data collection may or may not be transcribed, and wherein the system facilitates creation and management of intellectual property.

2. The system of recordkeeping of claim 1, wherein data objects are authenticated and secured from subsequent modification using one-way hashing.

3. The system of recordkeeping of claim 1, wherein the plurality of data objects are indexed (150) and represent a logical grouping of research activity, and further allow for paging such as provided in a traditional lab notebook.

4. The system of recordkeeping of claim 1, wherein the graphical user interface is controlled partially or completely by voice commands, and wherein the collection of data objects further comprises instrumentation data (112), and wherein the instrumentation data is selected from a group consisting essentially of mass spectrometers, camera images, microscope images, video, and chromatographs.

5. The system of recordkeeping of claim 1, wherein the researchers organize data objects according to organizational criteria, time, protocol, personnel, consumables, or sample identification, as applicable; and wherein the graphical user interface is controlled partially or completely by a smart pen.

6. The recordkeeping system recited in claim 1, wherein a system user is guided through the creation of an integrated data record by transcribing a scanned (121) lab notebook page (111) or wherein the user is guided through the creation of an integrated data record (220) by following an electronic lab notebook entry (201), and wherein the integrated data record is distributed to a relational database management system (RDMS) (410), with a generation of indexes comprised of metadata in the data record wherein the metadata further describes the data objects.

7. A method (100, 200, 300, 400) of voice data collection in a recordkeeping application as a way of converting data into electronically accessible text, the method comprising:
training a software program to recognize a user voice (132c) having a substantially high accuracy;
providing a technical database of scientific terms (132a, 132b) to enhance the software program to accurately recognize technical terms;
providing a database of scientific symbols to enhance the software program to accurately recognize and convert technical characters to text;
reading the data to be converted to text to the software program;
converting the data to text using the software program; and
supplementing the data with applicable analytical or empirical data (112) directly from scientific instrumentation wherein the resulting text (150) is electronically accessible.

8. The method of processing data of claim 7, the method further comprising recording data to a lab notebook (111), preceding the step of reading the data to be converted to text to the software program, wherein the data further includes date and time information.

9. The method of processing data of claim 7, the method further comprising:
providing to the software program a rules engine for quality assurance; and
validating results to further increase accuracy of the method.

10. The method of processing data of claim 1, the method further comprising:
indexing the electronically accessible text selectively as desired by the user; and
interrupting the electronically accessible text to enhance the usefulness thereof.

11. The method of processing data of claim 1, wherein the data is laboratory data, and further comprising supplementing the data with internet sources of research, the sources of research chosen from a group consisting essentially of a protein databank, a chemical structure libraries, and a genomic database.

12. A method (100, 200, 300, 400) of recordkeeping comprising:
collecting a plurality of data objects from data sources (111, 112, 113, 114, 202, 203, 204, 311, 312, 313, 314);
assembling the data objects to an integrated electronic notebook record (220);
assisting the assembly of data objects with computer assisted voice interaction (132);
securing (143) the assembly of data objects so that said data remains uncorrupted;
storing (150) the assembly of data objects; and
translating (142) the assembly of data objects to Extensible Markup Language (XML) to facilitate the sharing of structured data across an information system, for example the Internet.

13. The method of recordkeeping of claim 12, further comprising:
distributing the assembly of data objects to a relational database management system (RDMS) (410); and
generating indices comprised of metadata in the data record.

14. The method of recordkeeping of claim 12, further comprising:
providing a statistical analysis package (411) with the assembly of data objects;
providing pattern and clustering algorithms (412) related to the assembly of data objects;
providing data mining tools (413) related to the assembly of data objects, wherein the data mining tools comprises searching within the assembly of data objects by a protocol;
maintaining a modular software and hardware design so that existing labs can implement said method of recordkeeping relatively easily;
presenting the assembly of data objects using graphical data visualization tools (414); and
recording a status, the status chosen from a group consisting of DRAFT, COMPLETE, APPROVED, RELEASED, or CANCELLED.

15. The method of recordkeeping of claim 12 wherein the collecting a plurality of data objects from data sources comprises ambient data from real-time voice annotation (113), and wherein the assisting the assembly of data objects with computer assisted voice interaction comprises a speaker independent voice dictionary (132a), a special domain specific scientific vocabulary (132b), and a voice trained individual vocabulary (132c), the method further comprising ranking and scoring the data objects for subsequent decision makings regarding the accuracy and usefulness of the data objects.
